(19) United States
(12) Patent Application Publication
(10) Pub. No.: US 2008/0141213 A1
(43) Pub. Date: Jun. 12, 2008

(54) Flexible interconnection system

(76) Inventors: Karlheinz DORN, Kalchreuth (DE); Ralf HOFMANN, Puschendorf (DE)

Correspondence Address: HARNESS, DICKEY & PIERCE, P.L.C., P.O.BOX 8910, RESTON, VA, 20195, US

(21) Appl. No.: 11/976,807

(22) Filed: Oct. 29, 2007

(30) Foreign Application Priority Data
Oct. 30, 2006 (DE) 10 2006 051 188.3

(51) Int. Cl. G06F 9/44

(52) U.S. Cl. 717/100

(57) ABSTRACT

An interconnection system, a method for interconnecting different components and/or applications and a corresponding product are disclosed. In addition to a presentation layer, a business layer, a communication layer and a control layer, the framework system of at least one embodiment includes an instance which is intended to detect the current deployment environment in which the application is to run. In particular it is automatically detected here whether the application is to run as a web application or as a desktop application. Depending on this, the optimal infrastructure for the interconnection is provided automatically.

### PRIORITY STATEMENT

The present application hereby claims priority under 35 U.S.C. §119 on German patent application number DE 10 2006 051 188.3 filed Oct. 30, 2006, the entire contents of which is hereby incorporated herein by reference.

### FIELD

Embodiments of the invention generally relate to an interconnection system for a plurality of applications and/or application components, wherein the applications are computer-based.

### BACKGROUND

One key aim of modern software technology is to provide the greatest possible degree of flexibility and variability for the applications to be created or for the system of applications respectively. In particular, there are different deployment scenarios, e.g. the basic computer architecture on which the application is to run (for example web applications or desktop applications), computer resources that can be accessed, etc. It is desirable to be able to cover different deployment scenarios using one and the same application without any major changes. To date this has however not been possible with the system known from the prior art. In particular it was necessary to adapt a given infrastructure for the interconnection specifically to the respective deployment in each case.

In the method known to date, in particular it was necessary to differentiate between desktop applications on the one hand and web applications on the other hand during software development. In particular, the development engineer had to develop, update and maintain two different source code masters since no standardized interconnection system was available.

### SUMMARY

In at least one embodiment, the present invention discloses a way of improving, and in particular designing more flexibly, an interconnection system or a framework for a plurality of applications, so that different deployment scenarios can also be covered.

In at least one embodiment, the present invention will be described below with reference to the interconnection system. Any advantages, features and alternative embodiments mentioned in this respect are equally applicable to the method and to the product. Accordingly, the claims that are concerned with the method and/or the product can likewise be further developed with the features for the system and vice versa.

In at least one embodiment, an interconnection system is disclosed for the asynchronous interconnection of a plurality of components of an application (A), wherein in each case an application (A) can be broken down vertically and/or horizontally into a plurality of components which can be interconnected dynamically to form an application (A) that can also be distributed or executed across process and/or machine boundaries, the interconnection system including:
a deployment environment in which the application (A) runs in an executable,
   wherein the components also comprise communication components which are intended as interface(s) for the application (A) in the detected deployment environment,
   wherein the components, in particular the communication components, are interconnected in such a way that the application (A) and/or the components is/are dynamically and automatically adapted to the respective current deployment environment.

For interconnecting a plurality of components to form an application and/or applications, the interconnection system preferably comprises at least one framework comprising:
at least one presentation layer which is intended for presenting and/or displaying the data,
at least one business layer (also known as business logic layer) which serves for background processing of the data, and
at least one communication layer which provides communication components and executes communication between the components, applications and/or between the layers, wherein one or more communication components can be altered, replaced by other components or exchanged, deleted or added or otherwise altered without the application being affected by this (noticing anything) or without having to be retranslated. In other words, if the deployment environment changes in such a way that a changed interface becomes necessary, then the previous communication component can be replaced by a new implementation of the same.

The communication layer is consequently essentially independent of the respective deployment environment. A significant advantage of the present invention is therefore that one and the same source code can also be used for different deployment environments. For instance, one and the same source code can be used both for a web application and for a desktop application, without the application development engineer having to make further changes or adaptations.

In the context of at least one embodiment of the present invention, the term “communication” is to be understood as data exchange between different computer-based instances. The type of data transfer is not limited here, so that data can be exchanged both unidirectionally and bidirectionally.

An “application” is understood to refer to a single computer-based, in particular software-based, module. As a rule an application can be broken down into a plurality of components or application components. The individual components are assigned here to different layers of an application architecture.

In an example embodiment, the framework comprises three layers:
a presentation layer,
a business layer, and
a communication layer.

The presentation layer serves to present the data, in particular to display the data on a display device such as a screen, etc.

The business or business logic layer contains all business logic components and thus represents a background activity for processing the data.

The communication layer is a layer designed for handling data exchange between different instances. In the solution according to at least one embodiment of the invention, the communication layer is flexibly designed and consequently takes on the core functionality with respect to data exchange within the framework system. The communication layer is equipped with a detection mechanism, which in particular runs automatically, and consequently automatically detects the deployment environment in which the application is currently located. Depending on the current deployment environment, the communication layer initiates the assignment of the individual components to the relevant layers. This is preferably performed automatically.

The current deployment scenario for the respective application can consequently be completely decoupled from the embedding of the respective application in the framework—in particular with respect to the communication between the individual components. The current deployment environment can thus remain hidden from the application. The application development engineer need not make or initiate any further changes with respect to the communication mechanisms. If the framework solely comprises the three layers—as in the above-mentioned embodiment—then the communication layer additionally takes on the functionality of a control task, which in a different embodiment of the invention can be taken on by a control layer described further below.

According to at least one embodiment of the invention, all communication-related aspects for an application are centralized and provided in individual communication components. All interfaces for the application can be handled by way of the components.

In the context of at least one embodiment of the present invention, the term “deployment environment” is to be understood in broad terms and comprises all parameters relevant for running an application at runtime. Depending on the embodiment, more or fewer parameters can be used here. A distinction is customarily drawn here between a web deployment and a desktop deployment for the application. It is however also possible to take further parameters into account here, in particular memory-related parameters (for example the type and size of memory available), the number of screens connected, software-based and/or hardware-based instances available, etc. The deployment environment is fully defined at the runtime of the application. It is however possible to determine individual parameters of the deployment environment already at an earlier time, or to select only specific parameters, e.g. desktop deployment or web deployment. The deployment scenario for the application can be derived or generated on the basis of the determination of the respective deployment environment.

In at least one embodiment, the interconnection framework is based on the .NET technology from Microsoft. The interconnection framework comprises command and job handling mechanisms for the applications. The architecture of the framework comprises a plurality of layers. A layer is an abstraction level or a layer of a physical structure model respectively.

The framework is always independent of the content of the respective application, and consequently independent of the underlying functionality of the system. As a rule, however, the framework is used for medical applications in image processing, such as image data capture processes, post-processing processes or the like.

The applications are usually so-called highly interactive n-tier applications. In this context, “highly interactive” refers to a highly responsive behavior of the participating modules, components and/or instances, which usually results in extensive data exchange.

One important advantage of the flexible interconnection framework according to the invention is that it provides optimal support for different deployment models. A standardized interconnection system is provided for all (that is to say also for different) deployment environments. In relation to the interconnection, an infrastructure is therefore provided which is platform-independent, and which furthermore is independent of different versions and independent of a version hierarchy. As soon as a new version of an individual component can be bound into the framework, this is readily possible without further changes being required. The relevant interconnection structures are automatically adapted and provided as the infrastructure.

A physical architecture model which can be used in the solution according to the invention will be explained below. In this architecture model, the above-mentioned three layers (presentation layer, business layer and communication layer) are extended by two further layers. Even more layers may be provided in further embodiments, so that the architecture can map yet more extensive functionality (so-called n-layer architecture or n-tier architecture).

The presentation layer is the top layer in the hierarchy. This is followed by a control layer (also known as controller layer), which in turn is followed by the business layer. Further layers are a service layer for so-called stateful services and a service layer for so-called stateless services.

The n-tier applications preferably have at least one presentation layer for displaying information and for user interactions; a control layer (also known as controller layer) for controlling the taskflow, for controlling the presentation layer and for controlling the business layer; the business layer for processing data; a stateful access layer for accessing/providing data and services locally or over a network; and a stateless access layer for accessing/providing data and/or services locally and/or over a network. This five-tiered structure essentially corresponds to the model of a presentation, control and model or business layer already set out above, extended by access layers to provide data and services.

A key element of this aspect of the invention is the realization with two access layers, of which an upper one is stateful and a lower one is stateless. The stateful access layer provides all necessary functions for the presentation, controller and business layers above it, so that the latter do not usually need to access the lower stateless layer and therefore need not take the latter or its state into account. Rather, the stateful access layer is solely responsible for implementing all accesses to data and services. As a result, the layers lying above it need never be adapted with respect to the local or remote availability of the underlying layers, but rather remain unchanged following their programming, irrespective of the deployment environment.

According to at least one embodiment of the invention, the application can be or is broken down into different components which are then assigned vertically to the individual layers. A plurality of applications of an application group and/or a plurality of components of an application can also be interconnected horizontally. An application thus contains for example presentation logic components and business logic components. A control component which provides a hosting of the flexible interconnection system is generated between said components. The flexible interconnection system according to the invention enables the individual components, in particular the presentation logic components and the business logic components, to be used for different deployment scenarios as well. As a result, it is advantageously achieved that the application need not be changed even in the case of different deployments, so that it can run as an unchanged module in both a desktop deployment and in a web deployment. If the deployment environment changes (e.g. in the event of a changeover between offline mode and online mode or vice versa), neither the presentation logic, nor the business logic, nor the respective communication interfaces need be changed with respect to the application. Even if the deployment environment changes, the fundamental application architecture can therefore remain constant, and thus unchanged.

Basically two types of communication principle are provided. Firstly there is vertical communication which relates to communication between the respective layers. Secondly there is horizontal communication which relates to communication between different applications and/or different application components. Both communication principles are controlled by means of the communication layer.

According to at least one embodiment of the invention, the application layers communicate over the flexible communication layer. In particular, the latter is a specific interface for data transfer between the participating instances. The communication layer offers the application development engineer a particular API (Application Programming Interface). According to at least one embodiment of the invention, the deployment environment in which the respective application is located is now automatically detected. If a desktop deployment is detected, then implementation of the interface that relates to desktop deployment is automatically activated. Otherwise, if a web deployment was detected, the communication interface optimized for the respective deployment environment is automatically activated. In this case the implementation of the interface for web deployment is used. By virtue of the dynamic generation according to the invention of the communication layer with the implementations of the interface optimized for the respective deployment environment, it is expediently possible for the interface to be interchanged in a modular fashion without the application being affected by this, or without changes being necessary on the application side. In particular it is possible for a changed implementation of an API to be used on the framework side without the application noticing anything of this.

In an example embodiment of the invention, the interconnection framework comprises a strategy management component (synonymous with Central Strategy Manager, CSM for short). The component is a hierarchically higher instance which ensures that both job management and task management are executed in accordance with the same basic concept.

According to at least one embodiment of the invention, the strategy management component is an individual, separately executable program object, that is to say the entire code is located within a single so-called “executable”, which is handled accordingly on the operating system level. According to at least one embodiment of the invention, the strategy management component makes at least two management functions and preferably all the required management functions available to the business program components. According to at least one embodiment of the invention, the strategy management component contains all the necessary program code required for implementing the management functions, and consequently entirely relieves the individual business program components from performing this task. The business program components can be programmed during development in such a way that they now only address the required functions of the strategy management component by means of function or object calls. The strategy management component thus contains standardized interfaces which must be known to the programmers of the business program components and which can be addressed by all business program components. It is therefore a generic strategy management component which is addressed in an identical manner for all business program components and covers all the cases to expected for its respective management functions in its program code.

By virtue of the flexible design of the interconnection system, it is possible for the applications in the framework to be configured dynamically at runtime. In particular this can be performed depending on the respective deployment environment. It is possible to configure which parameters are to be taken into account when determining the deployment environment, and this is dependent on the scope of the respective embodiment.

In an example embodiment, the framework comprises an asynchronous operations manager which is preferably designed in the form of a separate component. Communication and/or interconnection strategies can be defined in said component. This requires definitions regarding how the components exchange data with one another or communicate with one another within an application or within an activity. The communication strategies relate to different parameters, for instance client/server request/response protocols, communication that is event-propagation-based, that is to say dependent on the occurrence of given configurable events, as well as job management processing based on general command handling mechanisms. In addition to synchronization aspects, key aspects of a communication strategy are also data formats or message formats respectively, as well as aspects relating to the simultaneous execution of parallel threads.

The asynchronous operations manager implements all queues relating to commands and messages within the business components and service components. In particular, the asynchronous operations manager implements all working box thread message queues. From the internal point of view, the asynchronous operations manager can be combined with central job management in order to support central queuing based internally on an MSMQ, .NET remoting and on an SCOP application block. According to the invention, this enables central management of asynchronous command structures within the components by means of configuration on the component level or on the hierarchical level of the components respectively. Depending on the desired embodiment, it is possible to configure whether central or decentralized management of jobs is performed over a job consumer interface.

In a further development of at least one embodiment of the invention, the interconnection system is designed for controlling asynchronous operations within individual components and/or for managing multiple return values in relation thereto and for calling in the correct thread context.

In addition, differentiation between version-dependent and version-independent communication components can be provided. This is done on the basis of versionable application interfaces.

In an example embodiment, the interconnection system or interconnection mechanism comprises so-called event channels for event propagation within an individual component.

The architecture according to at least one embodiment of the invention enables the infrastructure for the interconnection to be decoupled from the respective application components and consequently kept separate from them. The architecture or the framework is consequently not dependent on the communication queries and communication responses. It is therefore possible to use within a single process running on a machine one and the same component multiple times and/or in different deployments running on the same or on another machine. The components are thus modular and can be reused multiple times, which significantly enhances the deployment capability of the system, its maintainability and freedom from errors (in that a module need only be tested once to check it is free of errors, but can be used multiple times).

In an example embodiment, all management tasks (that is to say all administrative tasks relating to the respective application) are decoupled from the execution of a service “deployed” within a particular component. The decoupling or separation according to the invention of the management-related tasks from the execution of applications provides a much higher degree of flexibility and permits a central job processing queue to be provided for a complete system, with start/stop management for all jobs running on this machine, including command handling and taking account of asynchronous commands within the components which are provided via the asynchronous operations manager. This comprises services such as, for example, asynchronous commands, a batch processing, an interruption and a resumption of jobs, a prioritization of jobs, as well as a deletion (cancellation) of jobs.

The framework according to at least one embodiment of the invention comprises the provision of an asynchronous interface (API) and the provision of a synchronous interface (API) with a deadlock avoidance strategy.

A significant advantage and further flexibility of the solution according to at least one embodiment of the invention can be seen in the fact that the deployment environment also comprises a versioning of the respective applications and/or application components. In other words, the framework according to at least one embodiment of the invention enables the client and the server to communicate with each other even if different versions of one and the same application or application component are loaded on the client and on the server. The corresponding infrastructure for the interconnection is provided here automatically.

Every application built on the interconnection mechanism or framework according to at least one embodiment of the invention can be operated automatically—that is to say without changes to the application—in different deployment scenarios (e.g. in an offline mode or in an online mode) without the application development engineer having to develop and subsequently maintain different source code masters.

Moreover, the layer architecture of an application need only ever be created once. Once it has been defined, it can also be used for other deployment environments without further adaptation. This confers major competitive advantages, since application development times can be significantly shortened.

A further solution of the object according to at least one embodiment of the invention is a product that can be designed in particular as a computer program product and comprises hardware modules and/or software modules, and is intended for providing an infrastructure for the interconnection of a plurality of applications. The product is designed with the features of the system. It should be noted here that part of the product may be on a client and another remaining part may be on the server. In other embodiments, the product can equally well be designed as a distributed product on a different computer architecture.

A further solution is a method for providing a development environment for a plurality of applications, comprising:
providing a framework, preferably comprising the following layers:
at least one presentation layer intended to present the data,
at least one business layer which serves for background processing of the data, and
at least one communication layer intended for data exchange or communication between the components, applications and/or between the layers, as well as
at least one control layer intended for hosting a flexible interconnection system from the communication layer,
providing components which can be dynamically interconnected in each case to form at least one application and are assigned to individual layers and/or can be distributed across process and/or machine boundaries,
detecting a deployment environment in which the application is running or is to run,
interconnecting applications and/or their components depending on the detected deployment environment by adapting the flexible communication layer by means of the control layer to the detected current deployment environment by means of the optimized interconnection system, which is optimally adapted to the detected deployment environment, but which however remains encapsulated or hidden from the application. The application can also be executed in a single executable in each case, across process and/or machine boundaries if necessary.

An alternative solution provides a storage medium which is intended for storing the above-described computer-implemented method and can be read by a computer.

In addition it is possible for individual components of the above-described method to be executed in one saleable unit and the remaining components in a different saleable unit—as a distributed system so to speak.

### BRIEF DESCRIPTION OF THE DRAWINGS

The following detailed description of the figures discusses example embodiments, which are not to be understood as restrictive, with their features and further advantages with reference to the drawings, in which:

FIG. 1 shows an overview of a flexible communication layer and its inclusion in relation to other layers of a framework,

FIG. 2 shows central or decentralized management of jobs and/or tasks according to one embodiment of the invention.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described. Like numbers refer to like elements throughout. As used herein, the terms “and/or” and “at least one of” include any and all combinations of one or more of the associated listed items.

An embodiment of the invention relates to an interconnection mechanism or an interconnection system for providing an infrastructure for the interconnection of a plurality of applications A combined in the framework. An application A can be broken down into a plurality of components in each case or is structured in a modular fashion respectively; the components K can then be interconnected dynamically at runtime so that they can be automatically adapted to the respective current deployment environment.

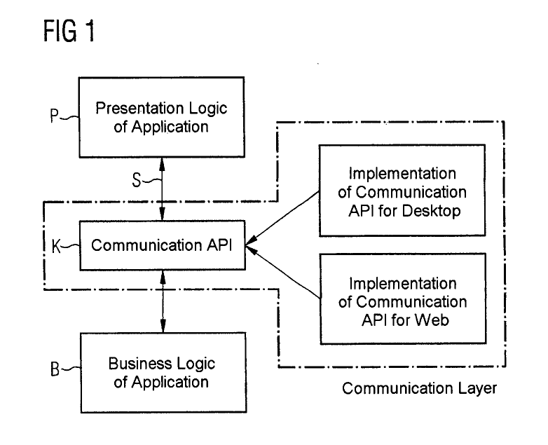

The framework comprises a hierarchy of multiple layers. This is illustrated in FIG. 1. The presentation layer P forms the top layer in the hierarchy, followed by a control layer S with a communication layer K. Under that is a business layer B, which in turn may be followed by further layers. In a preferred embodiment, the business layer B is supported by a service layer which offers so-called local “stateful” services. A service layer which offers “remote stateless” services can follow as the lowest layer.

FIG. 1 shows that the interconnection mechanism comprises a flexible communication layer K within a controller component of an application A. The application layers communicate over said communication layer K, which offers a specific interface or API.

The communication layer K interacts with the control layer S in such a way that an infrastructure optimally designed for the respective deployment environment can always be provided for the communication. In other words, according to an embodiment of the invention the deployment environment in which the respective application A is to run is automatically detected. In an example embodiment, the deployment environment constitutes parameters that define whether the application is to be used as a web application or as a desktop application. In addition, in alternative embodiments it is also possible to take into account further parameters that are relevant at runtime, such as memory-related parameters, the number of screens, etc. for example.

The control layer S thus detects automatically whether the application is deployed on a desktop or on the web. Depending on what is detected or determined here, the interconnection mechanism optimally designed for this case is automatically determined. This is preferably performed by using the appropriate implementation of the communication interface. It can consequently be ensured that the interconnection mechanism that is optimally adapted to the respective current deployment environment is always automatically provided and used. This method is dynamic and significantly enhances the flexibility of the framework system, in that also individual implementations of interfaces can also be interchanged—in modular fashion so to speak—on the framework side without the individual application A noticing anything or being affected by this. This is indicated in FIG. 1 with the reference symbol S on the arrow between the presentation layer P and the communication layer K.

As illustrated diagrammatically in FIG. 1, the communication layer K is arranged between the presentation layer P and the business layer B and comprises one implementation for desktop deployment and one implementation for web deployment. In advantageous further developments, however, the communication layer K can however also comprise further implementations that take account of further parameters of the deployment environment for example.

In the example embodiment, the interconnection mechanism is based on a system called SYNGO from Siemens which is known. However, the previous system has been extended to include the provision of the flexible communication layer K and adaptation to the respective current deployment environment by means of an asynchronous operations manager. An embodiment of the invention is based on COM+ and accesses Microsoft .NET technology.

The interconnection mechanism comprises a strategy management component CSM (CSM, Central Strategy Manager) in which general rules and strategies, in particular with respect to communication and/or interconnection, are stored. This includes for example rules that define how individual applications or activities are to communicate with one another, a general job management, and other management-related tasks that relate, for example, to command handling.

According to an embodiment of the invention, generalized command patterns can be provided, in particular as part of in-processing, out-processing and in relation to deployments between different machines, which are usually bundled as services and can be provided in a “deployable” component. The generalized command patterns are created according to predefinable criteria. It can consequently be ensured that certain features are observed in the command patterns. As a rule the following features are supported:
asynchronous API,
synchronous API with deadlock avoidance strategies,
multiple connection ports,
client/server channel per port,
request/response message channels,
strategies for different command execution models,
separate business logic containers,
separate binary programs (executables) with “argc,argv interface” (CGI exe),
business logic activation by means of a so-called “thread pool inproc optimizer”.

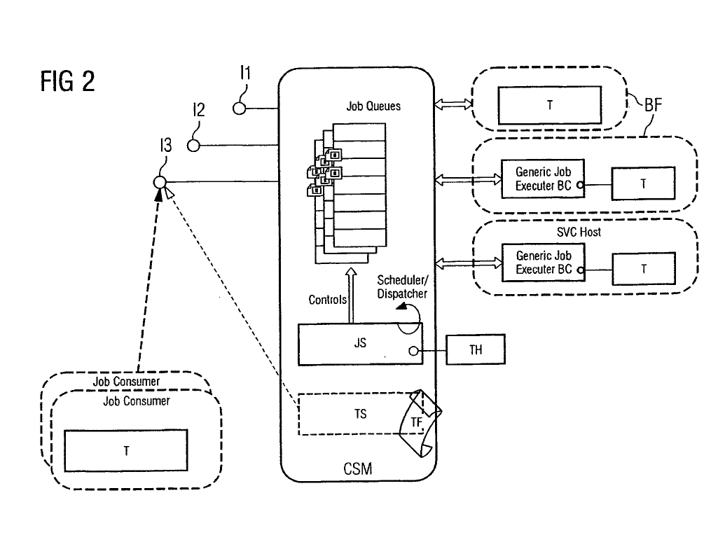

FIG. 2 shows the flexible communication according to an embodiment of the invention with job management and task management. The jobs and/or tasks T are centrally or decentrally managed via a job consumer interface here.

The central strategy manager CSM is intended for managing the job queues and preferably has the following interfaces: an interface for accessing the contents of a queue I1, an interface for controlling a queue I2, an interface for outputting jobs and for monitoring jobs I3. A taskflow manager subsystem TS accesses the interface I3. A job manager subsystem JS controls the queue and can have an interface to an external trigger handler TH. Among other things, the trigger handler TH controls when and how a job should change its status from “incoming” to “scheduled for execution” so that, for example, SCOB jobs are only executed if the network is actually available. The queue thus comprises a sequence of “job for executer AB”, “job for executer XY” etc. The job manager subsystem JS and the queue and taskflow manager subsystem TS it controls are integrated in the strategy management component CSM. In some circumstances the latter interacts across process and/or machine boundaries with business forms BF, which in addition to a task/job business component may comprise a generic job execution component (generic job executer BC) in each case.

In the example embodiment, the solution according to the invention is based on a generic computer program module that has been extended according to the invention (namely with the flexible communication layer for adaptation to the respective deployment environment, the asynchronous operations manager component which provides a communication infrastructure that is independent of the respective version or implementation of the respective application A). The known system is already published in EP1037142A2, the entire contents of which are hereby incorporated herein by reference.

Finally, it is noted that the above description of example embodiments of the invention are to be understood fundamentally as non-restrictive with respect to a specific physical realization of at least one embodiment of the invention, and consequently can also be modified in various ways without departing from the scope of the invention. In particular, it is obvious to a person skilled in the art that at least one embodiment of the invention can also be realized as a heterogeneous system, partially or completely by software and/or hardware modules and/or distributed over a plurality of physical products—in particular also computer program products. It is moreover possible to deploy the solution according to at least one embodiment of the invention as a module in order to integrate it in existing systems.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDS; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An interconnection system for the asynchronous interconnection of a plurality of components of an application, wherein in each case an application can be broken down at least one of vertically and horizontally into a plurality of components which are dynamically interconnectable to form an application that is also at least one of distributable and executable across at least one of process and machine boundaries, the interconnection system comprising:
a deployment environment in which the application runs in an executable, wherein the components also comprise communication components which are intended as at least one interface for the application in the detected deployment environment, and wherein the components, in particular the communication components, are interconnected in such a way that at least one of the application and the components is dynamically and automatically adapted to the respective current deployment environment.

2. The interconnection system as claimed in claim 1, wherein the system comprises at least one framework, including:
a presentation layer to present the data;
a business layer for background processing of the data;
a communication layer intended for communication between at least one of the applications and the layers by way of accessing the interconnection system; and
a control layer for hosting the interconnection system.

3. The interconnection system as claimed in claim 1, wherein the deployment environment comprises at least of the following parameters:
web deployment;
desktop deployment;
at least one of version of the application and version of the components;
memory-related parameters;
number of screens; and
other parameters that are relevant at runtime.

4. The interconnection system as claimed in claim 1, further comprising a strategy management component designed for the dynamic interconnection of the respective component depending on the respective deployment environment.

5. The interconnection system as claimed in claim 1, wherein the application is dynamically configurable at runtime by way of the interconnection system.

6. The interconnection system as claimed in claim 1, wherein different deployment scenarios are coverable by one source code with respect to an application, without the application having to be altered.

7. The interconnection system as claimed in claim 1, wherein management-related tasks are decoupled from an execution of the application.

8. The interconnection system as claimed in claim 1, wherein at least one of central and decentralized management of at least one of jobs and applications is provided.

9. The interconnection system as claimed in claim 1, wherein a queuing is provided for at least one of applications to be executed and executed applications.

10. The interconnection system as claimed in claim 1, wherein at least one of a synchronous and an asynchronous interface is provided for communication.

11. The interconnection system as claimed in claim 1, wherein the deployment environment comprises a versioning of the application, so that a first version of the application running on a first computer instance is also communicatable with at least one of a second version of the same application and another application stored on a second computer instance.

12. A method for the asynchronous interconnection of components to form an application, comprising:
providing a framework including a plurality of vertically arranged layers;
providing horizontally arranged components which are interconnectable to form at least one application and are assigned to the respective layers, and which are provided distributed across at least one of process and machine boundaries if necessary;
detecting a deployment environment in which the application is running;
detecting communication components required for the application in the detected deployment environment;
selecting the interconnection system which is best adapted to the detected deployment environment while determining the components relevant to the detected deployment environment; and
interconnecting relevant components for the application depending on the detected deployment environment for the purpose of execution in an executable.

13. A computer program product, which can be loaded directly into a memory of a computer, comprising software code sections with which the method steps as claimed in claim 12 are executable when the product is executed by a processor on a computer.

14. The interconnection system as claimed in claim 1, wherein the components are communication components.

15. The interconnection system as claimed in claim 1, wherein the deployment environment comprises at least of the following parameters:
web deployment;
desktop deployment;
at least one of version of the application and version of the components;
memory-related parameters;
number of screens; and
other parameters that are relevant at runtime.

16. The interconnection system as claimed in claim 6, wherein a communication component of the application is at least one of replaceable by another and otherwise altered without the application having to be recompiled with the at least one of replaced and altered communication component.

17. The interconnection system as claimed in claim 7, wherein the management-related tasks include job management and task management.

18. The interconnection system as claimed in claim 9, wherein the queuing is provided for at least one of applications to be executed and executed applications in components of at least one of a business layer and a service layer.

19. A computer readable medium including program segments for, when executed on a computer device, causing the computer device to implement the method of claim 12.

20. The computer program product of claim 13 wherein the computer program product is a computer readable medium.
